(19) United States
(12) Patent Application Publication
(10) Pub. No.: US 2017/0269403 A1
(43) Pub. Date: Sep. 21, 2017

(54) LIQUID CRYSTAL CELL, METHOD FOR MANUFACTURING LIQUID CRYSTAL CELL AND DISPLAY PANEL

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Feifei ZHANG, Beijing (CN); Xiaohui YI, Beijing (CN); Zhinan ZHANG, Beijing (CN)

(73) Assignees: BOE TECHNOLOGY GROUP CO., LTD., Beijing (CN); BEIJING BOE OPTOELECTRONICS TECHNOLOGY CO., LTD., Beijing (CN); BEIJING BOE OPTOELECTRONICS TECHNOLOGY CO., LTD., Beijing (CN)

(21) Appl. No.: 15/326,403

(22) PCT Filed: Jul. 5, 2016
(86) PCT No.: PCT/CN2016/088578

§ 371 Date: Jan. 13, 2017

(30) Foreign Application Priority Data
Oct. 12, 2015 (CN) 201510655153.4

(51) Int. Cl. G02F 1/1339; G02F 1/1335; G02F 1/1368; G02F 1/1341

(52) U.S. Cl. CPC G02F 1/1339; G02F 1/1341; G02F 1/133514; G02F 1/1368; G02F 1/13394; G02F 2202/28; G02F 2202/023; G02F 2001/133354

(57) ABSTRACT

The embodiments of the present disclosure provide a liquid crystal cell, a method for manufacturing the liquid crystal cell and a display panel. The method for manufacturing the liquid crystal cell comprises: forming a fixed retaining wall structure on a first substrate, at least a part of the fixed retaining wall structure being used for forming a border of the liquid crystal cell; injecting liquid crystal into the retaining wall structure; forming a first pure heat curing adhesive on a second substrate for sealing the border of the liquid crystal cell; performing cell aligning to the first substrate and the second substrate, thereby aligning the retaining wall structure on the first substrate with the first pure heat curing adhesive on the second substrate; and performing heat curing to the first pure heat curing adhesive, thereby sealing the border of the liquid crystal cell.

### TECHNICAL FIELD

The present disclosure relates to the field of liquid crystal display panel, in particular to a liquid crystal cell, a method for manufacturing the liquid crystal cell and a display panel.

### BACKGROUND

Liquid crystal display panel has become a mainstream in display panels and has been widely used in the field of display due to its outstanding advantages. It has been widely used in various small-sized portable electronic products.

Liquid crystal cell is a basic component of the liquid crystal display panel, which comprises a TFT (thin film transistor) substrate, a CF (color filter) substrate and a liquid crystal layer formed between the TFT substrate and the CF substrate. In the process of manufacturing the liquid crystal cell, the liquid crystal layer should be sealed according to a display size to form a liquid crystal cell with a corresponding size.

FIG. 1 is a schematic diagram of a liquid crystal cell in an existing process of sealing and curing. In the existing production process of the liquid crystal cell, as shown in FIG. 1, after the TFT substrate 11 is aligned with the CF substrate 12, the frame is sealed with a mixed sealant 13 of UV (ultraviolet radiation) and heat curing type. In the process of sealing and curing: firstly, the sealant 13 is cured with UV, so that the sealant 13 is partially cured, preventing the liquid crystal from spreading to the outside; then heat curing is performed to the sealant 13, so that the sealant 13 is fully cured. However, in the UV curing process, as shown in FIG. 1, though blocked by a mask plate 15, UV will inevitably radiate to the PI (polyimide) alignment layer 14 on the edge of the sealant 13, thereby generating ions (e−) in the peripheral border region 141 of the liquid crystal cell. For a liquid crystal panel formed with such a liquid crystal cell, during lighting the liquid crystal panel, the ions generated on the peripheral border region 141 of the liquid crystal cell will cause a difference of voltage between the peripheral border region and the normal region, causing abnormal deflection for the liquid crystal near the border of the liquid crystal cell. Therefore, the peripheral border region of the display panel is apt to display abnormally, forming a “border Mura” phenomenon (such as a phenomenon of uneven display brightness or forming traces).

The above issues are relatively prominent in small-sized display panels, especially in display panels with a narrow border and small size.

### SUMMARY

With the embodiments of the present disclosure, the UV radiation effect on the PI alignment layer of the liquid crystal cell can be avoided, which may occur during performing UV curing to the sealant of the liquid crystal cell, thereby avoiding the border Mura phenomenon in the display panel.

To this end, the embodiments of the present disclosure provide the following solutions.

According to an aspect of the disclosure, an embodiment of the present disclosure provides a method for manufacturing a liquid crystal cell. The method comprises the following steps: forming a fixed retaining wall structure on a first substrate, at least a part of the fixed retaining wall structure being used for forming a border of the liquid crystal cell; injecting liquid crystal into the retaining wall structure; forming a first pure heat curing adhesive on a second substrate for sealing the border of the liquid crystal cell; performing cell aligning to the first substrate and the second substrate, thereby aligning the retaining wall structure on the first substrate with the first pure heat curing adhesive on the second substrate; and performing heat curing to the first pure heat curing adhesive, thereby sealing the border of the liquid crystal cell.

According to an embodiment of the disclosure, in the method for manufacturing a liquid crystal cell, the step of forming a fixed retaining wall structure on a first substrate comprises: coating a second pure heat curing adhesive on the first substrate; and performing heat curing to the second pure heat curing adhesive, thereby forming the retaining wall structure.

Optionally, the first pure heat curing adhesive or the second pure heat curing adhesive is epoxy resin, acrylic resin, heat curing agent or a mixture of at least two of them.

Optionally, the first pure heat curing adhesive and the second pure heat curing adhesive are made of the same material.

According to an embodiment of the disclosure, in the method for manufacturing a liquid crystal cell, the retaining wall structure is formed with a resin material or acrylic polymer.

According to an embodiment of the disclosure, in the method for manufacturing a liquid crystal cell, the heat curing process is performed at 150° C.-230° C. for 20-40 minutes.

According to an embodiment of the disclosure, in the method for manufacturing a liquid crystal cell, a height of the retaining wall structure is ½ to ¾ of a thickness of the liquid crystal cell.

According to an embodiment of the disclosure, in the method for manufacturing a liquid crystal cell, the first substrate is one of a CF substrate and a TFT substrate, the second substrate is another of a CF substrate and a TFT substrate.

According to an embodiment of the disclosure, in the method for manufacturing a liquid crystal cell, during the step of cell aligning, the retaining wall structure is covered by the first pure heat curing adhesive.

According to another aspect of the disclosure, an embodiment of the present disclosure provides a liquid crystal cell manufactured with any one of the abovementioned methods.

According to yet another aspect of the disclosure, an embodiment of the present disclosure provides a display panel comprising the abovementioned liquid crystal cell.

According to the embodiments of the disclosure, during the entire manufacture process of the liquid crystal cell, UV curing is not required. In particular, after the cell aligning operation is performed, only heat curing should be performed. Therefore, the UV radiation effect on the PI alignment layer of the liquid crystal cell can be avoided, which may occur during performing UV curing to the sealant of the liquid crystal cell; no ion is generated on the peripheral border region of the liquid crystal cell, thereby avoiding the border Mura phenomenon in the display panel. The display panel formed with the liquid crystal cell according to the embodiment of the disclosure has the advantage of good display effect near the border.

### BRIEF DESCRIPTION OF THE DRAWINGS

In order to more clearly illustrate the technical solutions and advantages in embodiments of the disclosure, the detailed description in combination with the appended drawings will be introduced.

FIG. 1 is a schematic diagram of a liquid crystal cell in an existing process of sealing and curing;

FIG. 2 is a flow chart of a method for manufacturing a liquid crystal cell according to an embodiment of the disclosure;

FIG. 3 shows the manufacture of a liquid crystal cell according to the manufacturing method of FIG. 2;

FIG. 4 is a flow chart of a method for manufacturing a liquid crystal cell according to another embodiment of the disclosure; and

FIG. 5 shows the manufacture of a liquid crystal cell according to the manufacturing method of FIG. 4.

### DETAILED DESCRIPTION

In the following, the technical solutions in embodiments of the disclosure will be described clearly and completely in connection with the drawings in the embodiments of the disclosure. Obviously, the described embodiments are only part of the embodiments of the disclosure, and not all of the embodiments. Based on the embodiments in the disclosure, all other embodiments obtained by those of ordinary skills in the art under the premise of not paying out creative work pertain to the protection scope of the disclosure.

In the drawings, for the sake of clarity, the thickness of some layers and regions is exaggerated; the size proportional relation between the components in the drawings is only schematic, it does not reflect the actual size proportional relation between the components.

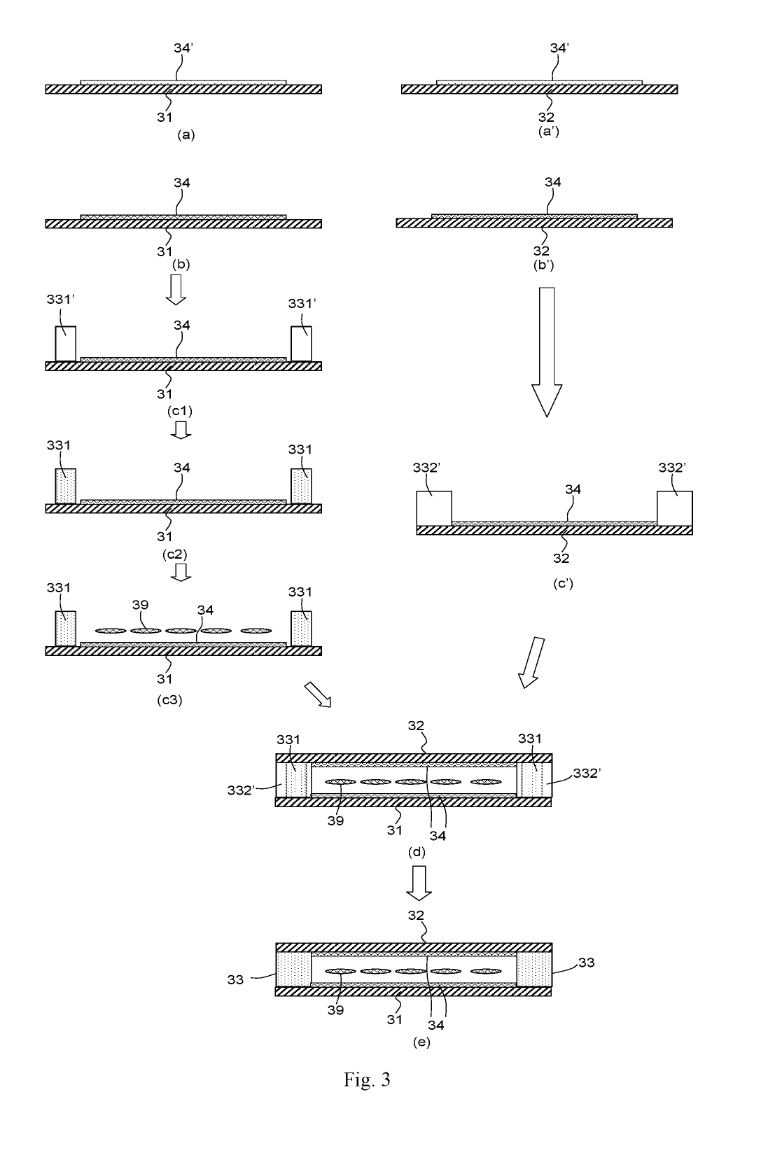

FIG. 2 is a flow chart of a method for manufacturing a liquid crystal cell according to an embodiment of the disclosure, and FIG. 3 shows the manufacture of a liquid crystal cell according to the manufacturing method of FIG. 2. Referring to FIG. 2 and FIG. 3, a method for manufacturing a liquid crystal cell shown in FIG. 3(e) is exemplarily illustrated.

In step S210, PI (polyimide) films are coated on a first substrate and a second substrate and cured. As shown in FIG. 3(a) and FIG. 3(a′), FIG. 3(a) shows a PI film 34′ being coated or printed on the first substrate 31; FIG. 3(a′) shows a PI film 34′ being coated on the second substrate 32. The PI film 34′ is used for forming an alignment layer. The specific thickness and the coating process of the PI film 34′ are not limited. For example, PI liquid can be printed in a composition process. The first substrate 31 can be a TFT substrate with a TFT array formed thereon. The second substrate 32 can be a CF (color filter) substrate (also known as color film substrate). In other embodiments, the first substrate 31 may also be a CF substrate, and the second substrate 32 may also be a TFT substrate.

Further, in step S220, a PI alignment layer is formed by performing rubbing alignment to the PI film. See FIG. 3(b) and FIG. 3(b′), a rubbing alignment process is performed to the PI films 34′ on the first substrate 31 and the second substrate 32, forming PI alignment layers 34. In other embodiments, an illuminating alignment process can also be used.

Further, step S231 to step 233 are performed to the first substrate.

In step S231, a pure heat curing adhesive is coated on the first substrate. As shown in FIG. 3(c1), a pure heat curing adhesive 331′ is coated at a position on the first substrate 31 for forming a border of the liquid crystal cell. In this embodiment, the pure heat curing adhesive 331′ is used to form a retaining wall structure preventing the liquid crystal from spreading to the outside. The pure heat curing adhesive 331′ is a sealant material which can be cured with only heat curing. The pure heat curing adhesive 331′ can be epoxy resin, acrylic resin, heat curing agent or a mixture of at least two of these materials.

In step S232, a retaining wall structure is formed by performing heat curing to the pure heat curing adhesive. As shown in FIG. 3(c2), the pure heat curing adhesive 331′ is cured by heat curing, forming a retaining wall structure 331. The height and/or width of the retaining wall structure 331 can be determined based on the height and/or width of the border for the liquid crystal cell to be formed. In particular, the heat curing process is performed at 150° C.-230° C. (e.g., 200° C.) for 20-40 minutes (e.g., 30 minutes). The height of the retaining wall structure is ½ to ¾ (e.g., ⅗) of the thickness of the liquid crystal cell to be formed.

In step S233, liquid crystal is injected. As shown in FIG. 3(c3), liquid crystal 39 is injected into the region surrounded by the retaining wall structure 331, to form a liquid crystal layer in the liquid crystal cell. The retaining wall structure 331 can thus be used for preventing the liquid crystal 39 from spreading to the outside.

Simultaneously, step S234 can be performed to the second substrate. A pure heat curing adhesive is coated on the second substrate. As shown in FIG. 3(c′), a pure heat curing adhesive 332′ is coated at a position on the second substrate 32 for forming a border of the liquid crystal cell. The pure heat curing adhesive 332′ is used to seal the border of the liquid crystal cell and form a border with good sealing property. The pure heat curing adhesive 332′ is a sealant material which can be cured with only heat curing. The pure heat curing adhesive 332′ can be epoxy resin, acrylic resin, heat curing agent or a mixture of at least two of these materials.

Further, in step S240, a cell aligning process is performed to the first substrate and the second substrate. As shown in FIG. 3(d), in the cell aligning process, the retaining wall structure 331 on the first substrate 31 is aligned with the pure heat curing adhesive 332′ on the second substrate 32 and substantially adhered to the pure heat curing adhesive 332′. Liquid crystal 39 is then arranged between the first substrate 31 and the second substrate 32.

Further, in step S250, a heat curing process is performed to the pure heat curing adhesive on the second substrate, thereby sealing the border of the liquid crystal cell. As shown in FIG. 3(e), by sending the structure of FIG. 3(d) into a heat curing device and performing a heat curing process to the structure, the pure heat curing adhesive 332′ is heat cured and combined with the retaining wall structure 331, forming a border 33 with a good sealing property. In this embodiment, substantially the entire border 33 is made of a material, which is formed with the pure heat curing adhesive through heat curing.

Then, the liquid crystal cell shown in FIG. 3(e) is basically finished. In particular, after the cell aligning operation is performed, only heat curing should be performed; the UV curing process is not required. Therefore, in the step for sealing the border of the liquid crystal cell (i.e., step S250), the UV radiation effect on the PI alignment layer 34 of the liquid crystal cell can be avoided, which may occur during performing UV curing to the sealant of the liquid crystal cell; no ion is generated on the peripheral border region of the liquid crystal cell, thereby avoiding the border Mura phenomenon in the display panel.

Moreover, in this embodiment, pure heat curing adhesive is applied on both of the upper substrate and lower substrate (i.e., the first substrate and the second substrate). That is, the retaining wall structure 331 and the pure heat curing adhesive 332′ have the same material properties, and compatibility is very good. Therefore, the border 33 formed with two curing processes has a good sealing property.

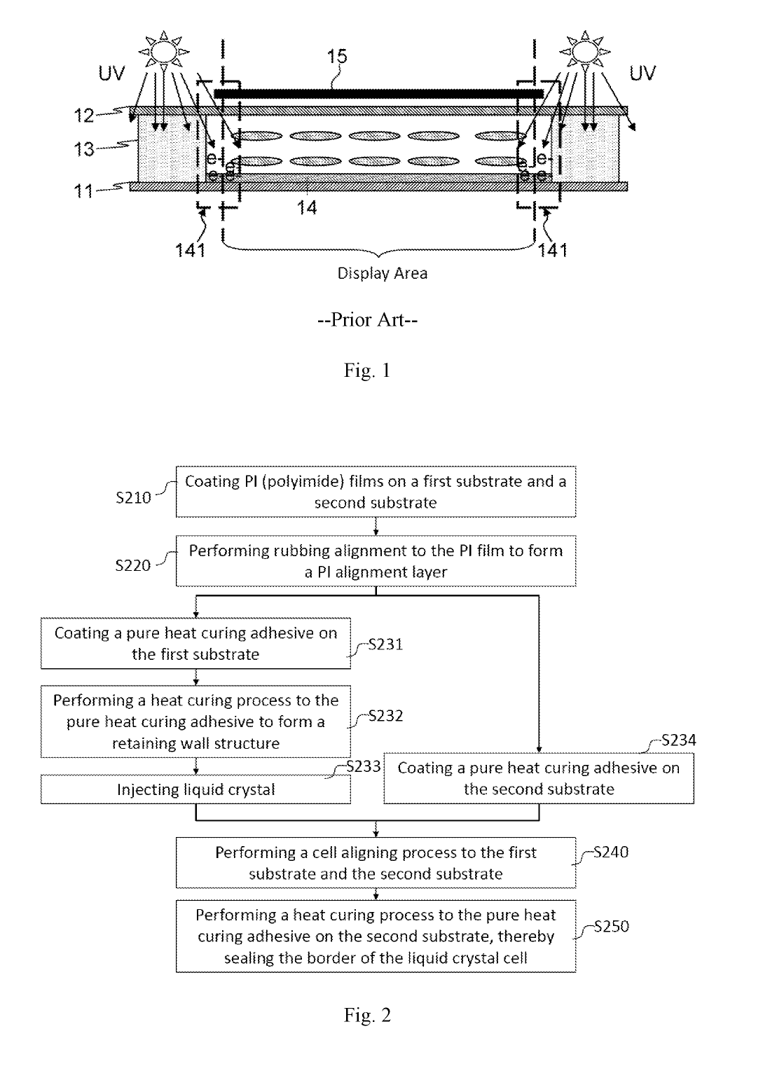

It should be noted that in the liquid crystal cell shown in the embodiment of FIG. 3(e), the border 33 is formed with cured pure heat curing material, which is different with the material of the sealant 13 shown in FIG. 1.

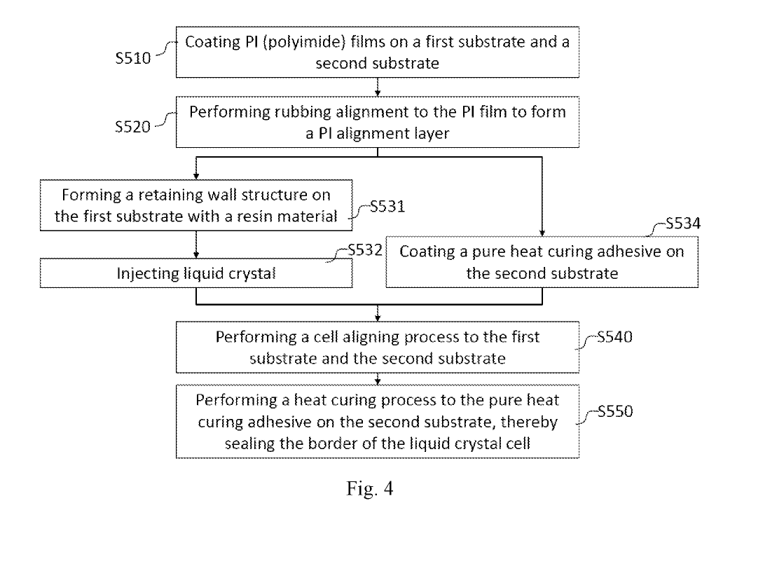

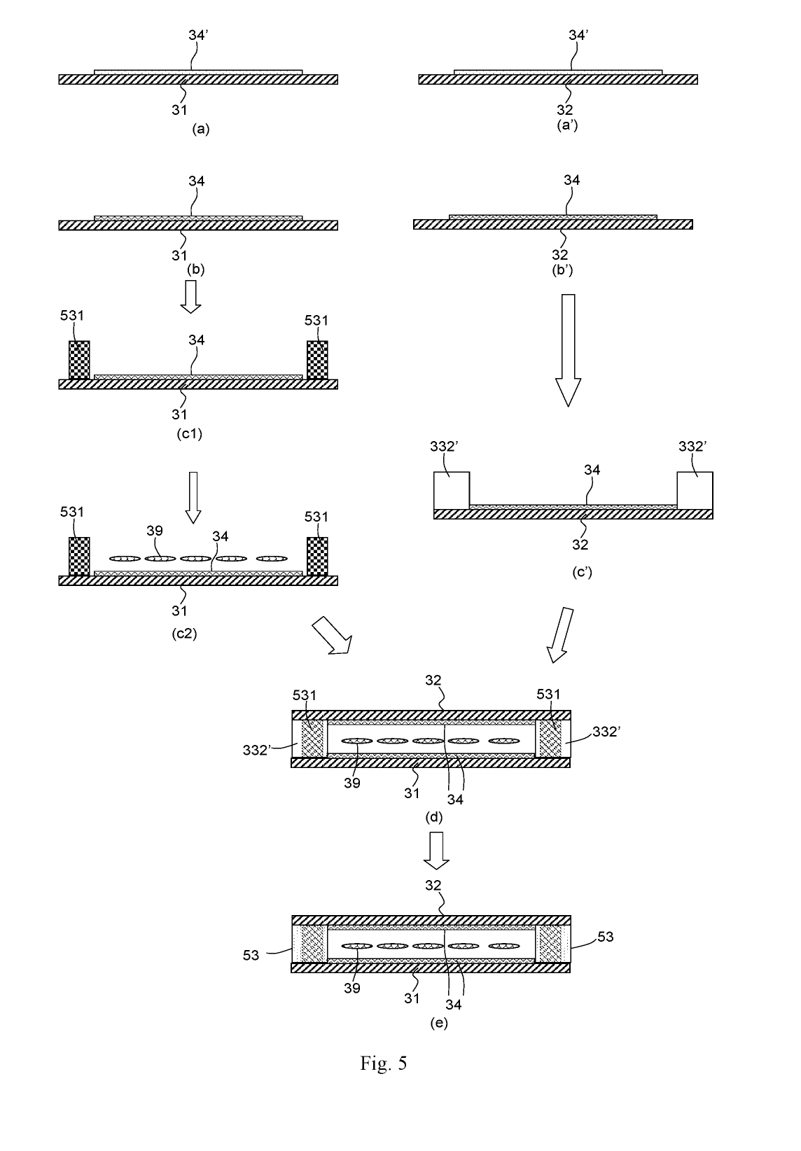

FIG. 4 is a flow chart of a method for manufacturing a liquid crystal cell according to another embodiment of the disclosure. FIG. 5 shows the manufacture of a liquid crystal cell according to the manufacturing method of FIG. 4. Referring to FIG. 4 and FIG. 5, a method for manufacturing a liquid crystal cell shown in FIG. 5(e) is exemplarily illustrated.

In step S510, PI (polyimide) films are coated on a first substrate and a second substrate and cured. As shown in FIG. 5(a) and FIG. 5(a′), FIG. 5(a) shows a PI film 34′ being coated or printed on the first substrate 31; FIG. 5(a′) shows a PI film 34′ being coated on the second substrate 32. The PI film 34′ is used for forming an alignment layer. The specific thickness and the coating process of the PI film 34′ are not limited. For example, PI liquid can be printed in a composition process. The first substrate 31 can be a TFT substrate with a TFT array formed thereon. The second substrate 32 can be a CF (color filter) substrate (also known as color film substrate). In other embodiments, the first substrate 31 may also be a CF substrate, and the second substrate 32 may also be a TFT substrate.

Further, in step S520, a PI alignment layer is formed by performing rubbing alignment to the PI film. See FIG. 5(b) and FIG. 5(b′), a rubbing alignment process is performed to the PI films 34′ on the first substrate 31 and the second substrate 32, forming PI alignment layers 34. In other embodiments, an illuminating alignment process can also be used.

Further, step S531 to step 532 are performed to the first substrate.

In step S531, a retaining wall structure is formed on the first substrate by applying a resin material. As shown in FIG. 5(c1), a retaining wall structure 531 is formed at a position on the first substrate 31 for forming a border of the liquid crystal cell. The retaining wall structure 531 can be formed with a mask process, which is not limited herein. Compared with the embodiment shown in FIG. 2, the retaining wall structure 531 is not formed by heat curing. The height of the retaining wall structure is ½ to ¾ (e.g., ⅗) of the thickness of the liquid crystal cell to be formed. In some embodiments, the retaining wall structure 531 can also be made of other macromolecular organic material (e.g., acrylate polymer), which is similar to the monomer structure of the pure heat curing adhesive used as a sealant.

In step S533, liquid crystal is injected. As shown in FIG. 5(c2), liquid crystal 39 is injected into the region surrounded by the retaining wall structure 531, to form a liquid crystal layer in the liquid crystal cell. The retaining wall structure 531 can thus be used for preventing the liquid crystal 39 from spreading to the outside.

Simultaneously, step S534 can be performed to the second substrate. A pure heat curing adhesive is coated on the second substrate. As shown in FIG. 5(c′), a pure heat curing adhesive 532′ is coated at a position on the second substrate 32 for forming a border of the liquid crystal cell. The pure heat curing adhesive 332′ is used to seal the border of the liquid crystal cell and form a border with good sealing property. The pure heat curing adhesive 332′ is a sealant material which can be cured with only heat curing. The pure heat curing adhesive 332′ can be epoxy resin, acrylic resin, heat curing agent or a mixture of at least two of these materials.

Further, in step 540, a cell aligning process is performed to the first substrate and the second substrate. As shown in FIG. 5(d), in the cell aligning process, the retaining wall structure 531 on the first substrate 31 is aligned with the pure heat curing adhesive 332′ on the second substrate 32 and substantially adhered to the pure heat curing adhesive 332′. The retaining wall structure 531 of resin material is substantially covered by the pure heat curing adhesive 332′. Liquid crystal 39 is then arranged between the first substrate 31 and the second substrate 32.

Further, in step S550, a heat curing process is performed to the pure heat curing adhesive on the second substrate, thereby sealing the border of the liquid crystal cell. As shown in FIG. 5(e), by sending the structure of FIG. 5(d) into a heat curing device and performing a heat curing process to the structure, the pure heat curing adhesive 332′ is heat cured and integrally cured together with the retaining wall structure 531, forming a border 53. In this embodiment, the border 53 comprises the cured pure heat curing adhesive and the retaining wall structure 531 of resin material.

Then, the liquid crystal cell shown in FIG. 5(e) is basically finished. In particular, after the cell aligning operation is performed, only heat curing should be performed; the UV curing process is not required. Therefore, the issues caused by the UV curing process are eliminated, thereby avoiding the border Mura phenomenon in the display panel. Moreover, in this embodiment, the resin material can be cured without UV curing process; the resin material is similar to the monomer structure of the pure heat curing adhesive. Therefore, the cured pure heat curing adhesive 332′ and the retaining wall structure 531 have a good compatibility, improving the sealing effect.

It should be noted that in the liquid crystal cell shown in the embodiment of FIG. 3(e), the border 33 is formed with the cured pure heat curing adhesive and the retaining wall structure 531 of resin material, which is different with the material of the sealant 13 shown in FIG. 1.

The methods for manufacturing a liquid crystal cell and the manufactured liquid crystal cells according to the embodiments of the disclosure are illustrated with the abovementioned implementations. The above embodiments are only used for explanations rather than limitations to the present disclosure, the ordinary skilled person in the related technical field, in the case of not departing from the spirit and scope of the present disclosure, may also make various modifications and variations, therefore, all the equivalent solutions also belong to the scope of the present disclosure, the patent protection scope of the present disclosure should be defined by the claims.

1. A method for manufacturing a liquid crystal cell, comprising:
forming a fixed retaining wall structure on a first substrate, at least a part of the fixed retaining wall structure being used for forming a border of the liquid crystal cell; injecting liquid crystal into the retaining wall structure;
forming a first pure heat curing adhesive on a second substrate for sealing the border of the liquid crystal cell;
performing cell aligning to the first substrate and the second substrate, thereby aligning the retaining wall structure on the first substrate with the first pure heat curing adhesive on the second substrate; and
performing heat curing to the first pure heat curing adhesive, thereby sealing the border of the liquid crystal cell.

2. The method according to claim 1, wherein forming a fixed retaining wall structure on a first substrate comprises:
coating a second pure heat curing adhesive on the first substrate; and
performing heat curing to the second pure heat curing adhesive, thereby forming the retaining wall structure.

3. The method according to claim 2, wherein the first pure heat curing adhesive or the second pure heat curing adhesive is epoxy resin, acrylic resin, heat curing agent or a mixture of at least two of them.

4. The method according to claim 3, wherein the first pure heat curing adhesive and the second pure heat curing adhesive are made of the same material.

5. The method according to claim 1, wherein the retaining wall structure is formed with a resin material or acrylic polymer.

6. The method according to claim 1, wherein the heat curing process is performed at 150° C.-230° C. for 20-40 minutes.

7. The method according to claim 1, wherein a height of the retaining wall structure is ½ to ¾ of a thickness of the liquid crystal cell.

8. The method according to claim 1, wherein the first substrate is one of a CF substrate and a TFT substrate, the second substrate is another of a CF substrate and a TFT substrate.

9. The method according to claim 1, wherein in the step of cell aligning, the retaining wall structure is covered by the first pure heat curing adhesive.

10. A liquid crystal cell manufactured with the method according to claim 1.

11. A display panel comprising the liquid crystal cell according to claim 10.

12. The liquid crystal cell according to claim 10, wherein forming a fixed retaining wall structure on a first substrate comprises:
coating a second pure heat curing adhesive on the first substrate; and
performing heat curing to the second pure heat curing adhesive, thereby forming the retaining wall structure.

13. The liquid crystal cell according to claim 12, wherein the first pure heat curing adhesive or the second pure heat curing adhesive is epoxy resin, acrylic resin, heat curing agent or a mixture of at least two of them.

14. The liquid crystal cell according to claim 13, wherein the first pure heat curing adhesive and the second pure heat curing adhesive are made of the same material.

15. The liquid crystal cell according to claim 10, wherein the retaining wall structure is formed with a resin material or acrylic polymer.

16. The liquid crystal cell according to claim 10, wherein the heat curing process is performed at 150° C.-230° C. for 20-40 minutes.

17. The liquid crystal cell according to claim 10, wherein a height of the retaining wall structure is ½ to ¾ of a thickness of the liquid crystal cell.

18. The liquid crystal cell according to claim 10, wherein the first substrate is one of a CF substrate and a TFT substrate, the second substrate is another of a CF substrate and a TFT substrate.

19. The liquid crystal cell according to claim 10, wherein in the step of cell aligning, the retaining wall structure is covered by the first pure heat curing adhesive.
